(19) United States
(12) Patent Application Publication
(10) Pub. No.: US 2011/0235465 A1
(43) Pub. Date: Sep. 29, 2011

(54) PRESSURE AND FREQUENCY MODULATED NON-LETHAL ACOUSTIC WEAPON

(75) Inventors: James H. Bostick, Tucson, AZ (US); Wayne Y. Lee, Vail, AZ (US); George D. Budy, Tucson, AZ (US); Steven J. Elder, Tucson, AZ (US)

(73) Assignee: Raytheon Company

(21) Appl. No.: 12/732,057

(22) Filed: Mar. 25, 2010

(51) Int. Cl. G10K 15/04; F41H 13/00; G01S 15/00

(52) U.S. Cl. 367/99; 367/139

(57) ABSTRACT

An acoustic weapon comprises a sonic pulse generator configured to generate discrete sonic pulses at a repetition rate. A sensor is configured to measure a range-to-target. A controller is configured to control the sonic pulse generator to generate a single shot including a burst of multiple pulses at a fixed repetition rate, to adjust the fixed repetition rate to shift the frequency content of the burst in accordance with a target coupling efficiency towards improving energy transfer to the target and to adjust the peak pressure of the burst in accordance with the range-to-target towards applying a specified peak pressure to the target. The controller may incorporate the target coupling efficiency as well as other parameters such as target apparent area and beam width when adjusting the weapon peak pressure. A pulse detonation engine (PDE) or pulse manifold (PM) may be modified and controlled to provide the large discrete peak pressures required at a periodic repetition rate.

### BACKGROUND OF THE INVENTION

1. Field of the Invention

This invention relates to non-lethal acoustic weapons and more particularly to control mechanisms to improve the effectiveness, safety and energy efficiency of such non-lethal acoustic weapons.

2. Description of the Related Art

“Since the early 1990s there has been an increasing interest—mainly in the U.S.—in so-called non-lethal weapons (NLW) which are intended to disable equipment or personnel while avoiding or minimizing permanent and severe damage to humans. NLW are thought to provide new, additional options to apply military force under post-Cold War conditions, but they may also be used in a police context. Whereas some foresee a military revolution and “war without death,” most others predict or prescribe that NLW would just augment lethal weapons, arguing that in actual war both types would be used in sequence or in parallel. However, there may be situations other than war when having more options of applying force below the threshold of killing could help to preven or reduce deaths, e.g. in a police context (riots, hostage-taking) or in peace-keeping operations. A range of diverse technologies has been mentioned, among them lasers for blinding, high-power microwave pulses, caustic chemicals, microbes, glus, lubricants, and computer viruses.” (Jurgen Altmann, “Acoustic Weapons—A Prospective Assessment, Science & Global Security: Volume 9, pp 165-234, 2001) Altman provides an analysis of acoutic weapons, with an emphasis on low-frequency sound, and particularly the effects on humans. Such weapons have been said to cause disorientation, nausea and pain without lasting effects. However, the possibility of serious organ damange and even death exists.

U.S. Pat. No. 5,973,999 to John T. Naff entitled “Acoustic Cannon” discloses an acoustic cannon having a plurality of acoustic sources with output ends symmetrically arranged in a planar array about a central point. Pressure pulses are generated in each acoustic source at substantially the same time. The pressure pulses exit the output ends as sonic pulses. Interaction of the sonic pulses generates a Mach disk, a non-linear shock wave that travels along an axis perpendicular to the planar array with limited radial diffusion. The Mach disk retains the intensity of the sonic pulses for a time and a distance significantly longer than that achievable from a single sonic source. The acoustic cannon is useful as a non-lethal weapon to disperse crowds or disable a hostile target. As graphically illustrated in FIG. 8, a sonic generator having a mass equivalent to the “total charge mass” equivalency of trinitrotoluene (TNT) is capable of producing a shock pulse effective to cause disorientation and debilitation, without permanent injury, over distances of from less than 10 meters to in excess of 100 meters. As illustrated in FIG. 7, attenuation increases as the frequency increases such that the maximum dominant frequency of the sonic pulses is preferably less than about 7 kHz, and more preferably, less than about 5 kHz. The sound intensity is selected to provide a desired effect to the biological target, dependent on the application. The FIG. 8 distances were computed based on a single sonic source and do not include the n^{2/3} factor that is obtained using multiple sources. As such, FIG. 8 illustrates the minimum over-pressure values at a given range for different values of the source strength (energy). Incorporation of the n^{2/3} factor for multiple sources substantially increases the effective range for a given over-pressure level.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention describes an acoustic weapon and more particularly describes control mechanisms to improve the effectiveness, safety and energy efficiency of such non-lethal acoustic weapons.

In an embodiment, an acoustic weapon comprises a sonic pulse generator configured to generate discrete sonic pulses at a repetition rate. A sensor is configured to measure a range-to-target. A controller is configured to control the sonic pulse generator to generate a single shot including a burst of multiple pulses at a fixed repetition rate, to adjust the fixed repetition rate to shift the frequency content of the burst in accordance with a target coupling efficiency towards improving energy transfer to the target and to adjust the peak pressure of the burst in accordance with the range-to-target towards applying a specified peak pressure to the target. The repetition rate within a burst may be between 20 Hz to 10 kHz to produce a center frequency positioned to couple to the resonance mode of a particular target. The frequency response of the burst may have a bandwidth no greater than 10% and suitably no greater than 5% of its center frequency. The controller may incorporate the target coupling efficiency as well as other parameters such as target apparent area and beam width when adjusting the weapon peak pressure. A pulse detonation engine (PDE) or pulse manifold (PM) may be modified and controlled to provide the large discrete peak pressures required at a periodic repetition rate.

In an embodiment, an acoustic weapon comprises a sonic pulse generator configured to generate discrete sonic. A sensor is configured to measure a range-to-target. A controller is configured to control the sonic pulse generator to adjust the peak pressure of a single shot including a burst of one or more sonic pulses in accordance with the range-to-target towards applying a specified peak pressure to the target. The controller may incorporate a target coupling efficiency as well as other parameters such as target apparent area and beam width when adjusting the weapon peak pressure. A pulse detonation engine (PDE) or pulse manifold (PM) may be modified and controlled to provide the large discrete peak pressures required at a periodic repetition rate. The burst may include multiple sonic pulses at a fixed repetition rate set to produce a frequency content that couples to the target.

In an embodiment, an acoustic weapon comprises a sonic pulse generator configured to generate discrete sonic pulses at a repetition rate. A controller is configured to control the sonic pulse generator to fire a single shot including a burst of multiple discrete sonic pulses at a fixed repetition rate. The frequency content of the burst of sonic pulses is controlled by the fixed repetition rate. The repetition rate within a burst may be between 20 Hz to 10 kHz to produce a center frequency positioned to couple to the resonance mode of a particular target. The frequency response of the burst may have a bandwidth no greater than 10% and suitably no greater than 5% of its center frequency.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a plot of peak pressure vs. range illustrating the capability to place a specified peak pressure on target over a range in accordance with the present invention;

FIGS. 2a through 2c are plots of pressure and frequency modulated bursts, a pressure modulated plane wave and absorption vs. frequency for different targets;

FIG. 3 is a block diagram of a pressure and frequency modulated non-lethal acoustic weapon;

FIG. 4 is a block diagram of a pressure modulated non-lethal acoustic weapon;

FIG. 5 is a block diagram of a non-lethal acoustic weapon that emits a burst of multiple pulses as a single shot;

FIG. 6 is an embodiment of a laser Doppler vibrometer for measuring absorption characteristics of a target;

FIGS. 7a and 7b illustrate an embodiment of an acoustic weapon configured as a phased array of sources mounted on a HUMVEE;

FIG. 8 is a block diagram of the phased array non-lethal acoustic weapon;

FIG. 9 is a flow diagram illustrating the operation and control of the weapon;

FIG. 10 is a diagram of a sonar reflectometer for measuring both absorption characteristics of and range to a target;

FIGS. 11a and 11b are diagrams of an embodiment of a Pulse Manifold for generating sonic pulses;

FIGS. 12a and 12b are a block diagram of a Pulse Detonation Engine (PDE) and a section-view of an embodiment of a PDE for generating sonic pulses; and

FIG. 13 is a diagram illustrating the use of superposition to combine sonic pulses from multiple sources to intensify the wave.

### DETAILED DESCRIPTION OF THE INVENTION

The present invention describes a controllable acoustic weapon well suited to address the concerns of military, police and human rights organizations and international law as regards effectiveness and safety and efficiency. Effectiveness and safety each would benefit from the capability to place a specified peak pressure on target and to couple the energy of that peak pressure to the target for a selected effect on a selected target. Efficiency would benefit from the capability to transfer energy efficiently from the weapon into the target.

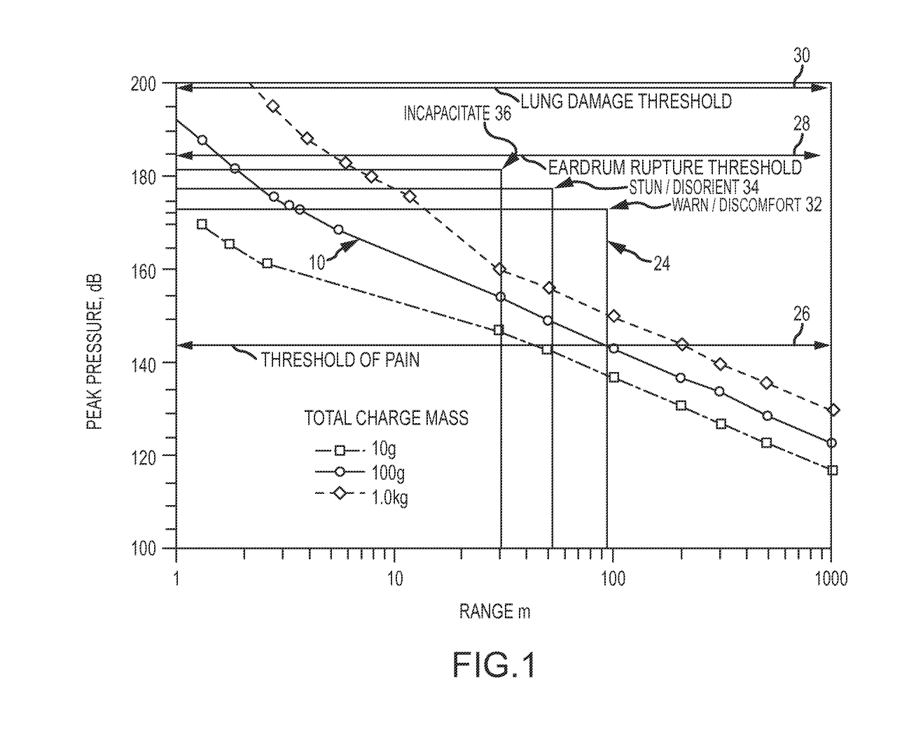

FIG. 1 is a plot of peak pressure versus range that provides for a comparison of the controllable acoustic weapon against a fixed acoustic weapon such as the Acoustic Cannon. Peak pressure in dB is twenty times the log base ten of the ratio of the overpressure to the ambient pressure (20 log₁₀(Pₒᵥₑᵣ/P_{tamb})). A fixed acoustic weapon combusts or detonates a fixed total charge mass to produce a single pulse as a single “shot”. As its name suggests the Acoustic Cannon is a single charge detonation that produces a large pulse. After each detonation the frangible diaphragm is replaced and another charge is loaded to fire another shot. The pulse intensity may be enhanced by configuring multiple sources in a phased array. This still produces a shot including a single pulse albeit of greater intensity. These weapons are not configured with the capability to vary the total charge mass or to otherwise control the peak pressure generated by the weapon. They do not measure the range to target. As such a given weapon will have a characteristic pressure curve 10 that falls off with range. These weapons are typically configured to generate sonic pulses as plane-waves or Mach disks so the pressure falls off approximately as 1/range. The effectiveness and safety of the weapon therefore depends on the range-to-target. If the target is too far away the shot will have little effect but if the target is too close serious injury could occur. Furthermore, the frequency content of a single pulse is ill defined. As a result, substantial energy is wasted and coupling to the target may be poor. Furthermore, if the coupling to the target is poor the peak pressure that is effectively coupled into the target may be much less than is at the target, further limiting the effectiveness of the weapon. Broadband energy may actually interfere with resonant coupling to the target. In addition, energy may be coupled into unintended targets with unintended consequences.

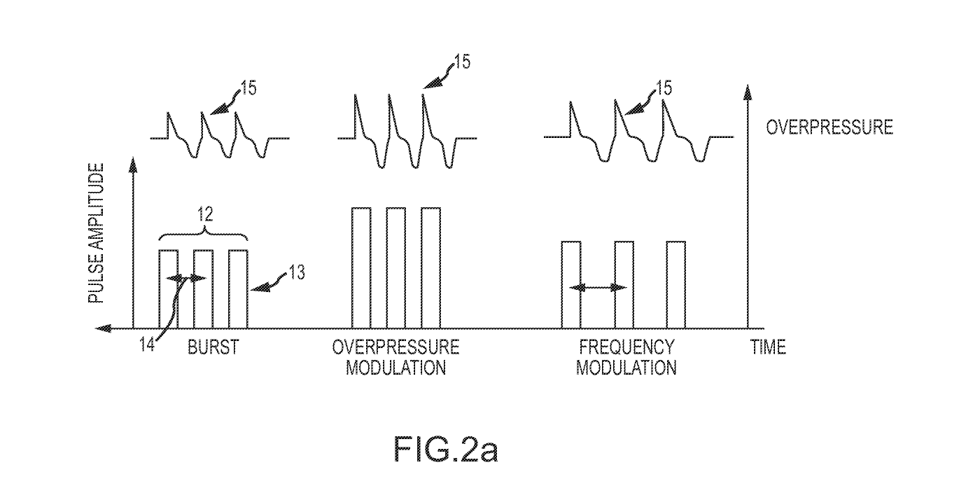

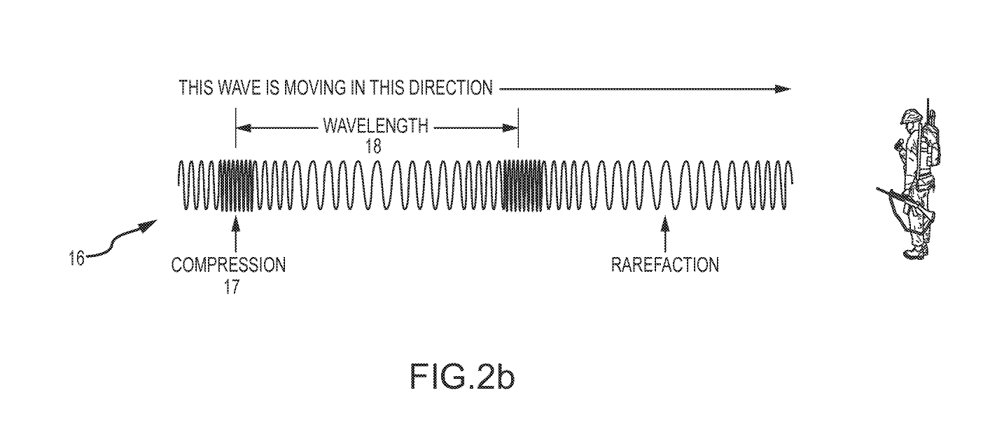

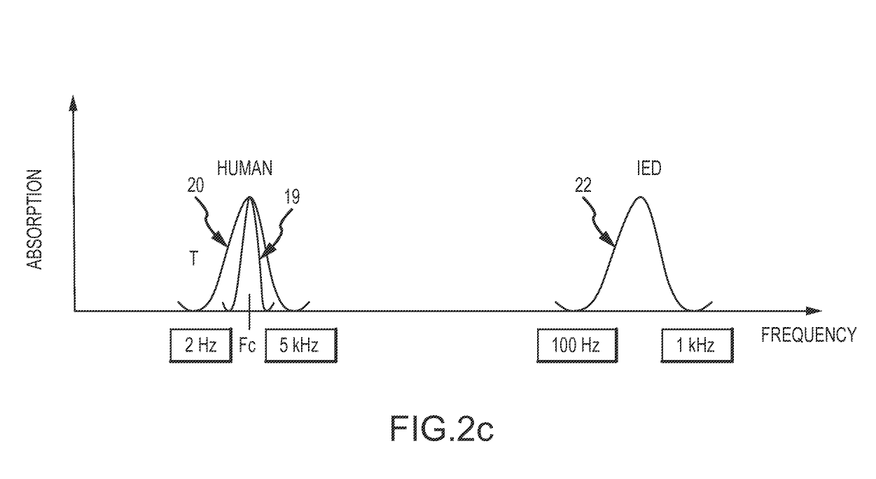

As shown in FIG. 1 and FIGS. 2a-2c, an embodiment of a controllable acoustic weapon may include one or more of the following attributes. First, the weapon may be configured to fire single shots that comprise a burst 12 of multiple pulses 13 at a fixed repetition rate 14 (e.g. period T). The weapon is suitably configured so that the pulses approximate a plane wave. The weapon transmits only the positive side of a waveform in pulse 13. Atmospherically supplied rarefaction provides the negative side of the waveform to place a pulse 15 on the target to apply the peak pressure. As shown in FIG. 2b, the pulse 15 at the target may also be depicted as a longitudinal wave 16 (plane wave). Longitudinal waves are waves that exhibit the same direction of oscillation along their direction of travel. The compression 17 of the wave corresponds to pulse 15 between areas of rarefaction. The wavelength 18 between compression/pulses corresponds to the repetition rate of the pulses and center frequency of the burst frequency content 19. Such a burst provides well-defined frequency content 19 about a center frequency (Fc). The repetition rate within a burst may be between 20 Hz (0.05 sec) to 10 kHz (0.0001 sec) to produce a center frequency positioned to couple to the resonance mode of a particular target. The frequency response of the burst may have a bandwidth 20 no greater than 10% and suitably no greater than 5% of its center frequency Fc. The frequency response is primarily defined by the uniform placement of multiple pulses within a burst and only secondarily defined by the configuration of the pulse generator itself. A well-defined frequency response couples more efficiently to the target and reduces the amount of wasted energy. Second, the weapon may be configured to adjust the fixed repetition rate 14 to shift the frequency content 19 of the burst in accordance with a target coupling efficiency (20 for human target, 22 for IED target) towards improving energy transfer to the target. The repetition rate within a burst is fixed and constant between pulses. That repetition rate may be adjusted to shift the frequency content for a given shot or between shots. Each target has certain absorption characteristics or resonant modes at which pressure energy is efficiently coupled to the target. Ideally, the center frequency Fc of the burst is aligned to the resonant mode (peak of the target coupling efficiency) to optimize the transfer of energy. The target coupling efficiency as a function of frequency may be measured in real-time for a particular target using, for example, a laser Doppler vibrometer or sonar reflectometer, or measured for a class of targets and stored in the weapon. Third, the weapon may be configured to adjust the peak pressure of the burst in accordance with the range-to-target towards applying a specified peak pressure 24 to the target. As shown in FIG. 1, the system or an operator select the target (e.g. human or IED) and select effect (e.g. warn/discomfort, stun/disorient or incapacitate for a human). The weapon looks, up the specified peak pressure 24 for the selected target and effect and calculates the weapon peak pressure based on a measured range-to-target. The weapon may also factor in the target coupling frequency, target apparent area, beam width and other environmental factors. As a result, the weapon cannot only place a specified peak pressure (approximately) at the target regardless of range (to an outer limit of the weapon) but can couple that specified peak pressure into the target. These attributes taken individually or in combination provide for controllability that improves effectiveness, safety and energy efficiency.

In an exemplary embodiment the acoustic weapon may be used as a non-lethal means against individual people or groups of people. Extensive testing on human subjects shows that a pain threshold 26 occurs at approximately 145 dB, an eardrum rupture threshold 28 at approximately 185 dB and a lung damage threshold 30 at approximately 198 dB. As shown a fixed charge mass weapon may produce a peak pressure on target that ruptures ears or damages the lungs or has little effect depending on the range of the target. Additional testing on human subjects has identified more finely resolved thresholds for desired effects on human targets including “warn/discomfort” 32 at approximately 172 dB, “stun/disorient” 34 at approximately 176 dB and “incapacitate” 36 at approximately 182 dB. To incapacitate the sonic pulses couple to the human pulmonary system (e.g. lungs) in such a manner that the subject has difficulty breathing to the point they become temporarily incapacitated. The controllable acoustic weapon allows the operator to select a target “human” and select one of the effects “warn/discomfort”, “stun/disorient” or “incapacitate”. The weapon measures range-to-target and possibly the absorption characteristics of the target, computes a firing solution and then fires a burst of one or more pulses to place the peak pressure associated with the selected effect on and coupled into the target. As the range-to-target changes, the weapon adjusts the firing solution to keep the same peak pressure on target. The controllability allows the acoustic weapon to be used effectively and safely to, for example, temporarily incapacitate a person without rupturing his or her eardrums. In another example, the operator could select the target, the effect and specify a perimeter range. The weapon would compute a firing solution and fire a sequence of shots over a wide beam width to establish a perimeter to keep people outside the perimeter.

The governing equations for the acoustic weapon are as follows:

P_{target}=P_{weapon}*(1/Rⁿ_{target})*α_{coupling efficiency} (1)

### Where

P_{target}=20 log₁₀(P_{target-over}/P_{target-amb}), P_{target}, P_{target-over} and P_{target-amb} are the peak, over and ambient pressures at the target;

P_{weapon}=20 log₁₀(P_{weapon-over}/P_{weapon-amb}), P_{weapon}, P_{weapon-over} and P_{weapon-amb} are the peak, over and ambient pressures at the exhaust port of the sonic pulse generator;

Rⁿ_{target} is the range-to-target from the weapon, where n is subject to empirical characterization for a particular device configuration; and

α_{coupling efficiency} is a combined coupling efficiency of energy into the target that accounts for losses present in the system. α_{coupling efficiency} is a function of frequency. Once the frequency content of the burst is determined a value for α_{coupling efficiency} may be computed. This value combined with the range-to-target and the specified peak pressure at the target determine the peak pressure, and particularly the overpressure, that must be generated by the weapon to couple the specified peak pressure into the target.

From the weapon to the target, α_{coupling efficiency} may account for one or more of the following losses:

Acoustic Coupling Efficiency (f)—attenuation coupling the pulses from the acoustic aperture at the exhaust port to the atmosphere. This is a design parameter of the weapon and calculable given the frequency content of the burst.

Atmospheric Propagation Efficiency (f,e,r)—attenuation of the sonic pulses through the atmosphere to the target is a function of the burst frequency content (f), environmental factors such as humidity and temperature (e) and range-to-target (r). Calculated from look-up tables based on range and frequency.

Ground Diffusion Efficiency (f, ground materials, range)—attenuation due to ground diffusion. The effect is typically small and may be ignored. Alternately, look-up tables based on the ground materials, frequency and range may be used. The operator could select the class of ground-materials to the target. Alternately, a sensor package could be included to measure the ground diffusion.

Target Coupling Efficiency (f)—attenuation due to absorption characteristics of the target. The target coupling efficiency may be measured offline for different classes of targets and stored in the weapon. Alternately, the target coupling efficiency may be measured in real-time for a particular target. The latter is generally more accurate but requires a sensor package on the weapon.

Target Apparent Area—area of the target illuminated by the beam. Area values may be assigned for target classes and stored in the weapon. Alternately, the target apparent area may be measured in real-time.

Beam width (f, aperture)—width of the beam at target is a function of the frequency content of the burst and design characteristics of the acoustic aperture. The beam width may be a fixed parameter for the weapon, fixed for each selectable target or variable. The beam width may be varied by operator selectable settings such as “single target” or “crowd” or may be varied by sensor data of the target area.

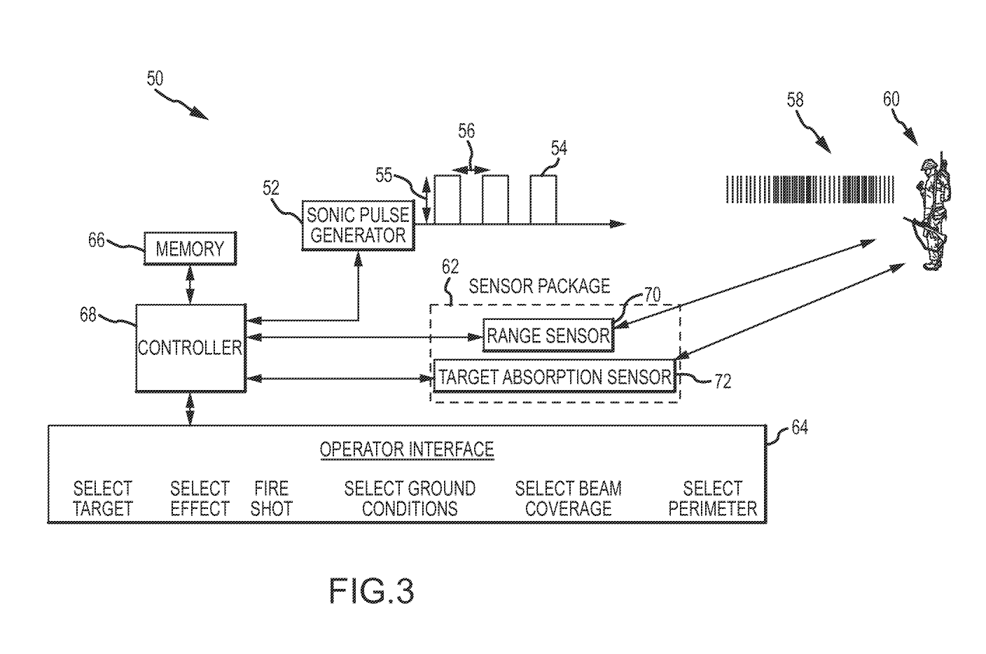

An embodiment of a controllable acoustic weapon 50 that incorporates each of the three attributes; multiple-pulse burst, modulation of the burst frequency and modulation of the burst peak pressure is depicted in FIG. 3. Acoustic weapon 50 includes a sonic pulse generator 52 configured to generate discrete sonic pulses 54 at amplitude 55 and repetition rate 56 to place pulses 58 (longitudinal wave) on a target 60, a sensor package 62 configured to measure range-to-target and target absorption characteristics to provide the Target Coupling Efficiency (f), an operator interface 64 for selection of various parameters such as target, effect etc. and for firing a shot, a memory 66 that stores data and parameters for the governing equation and a controller 68 that receives data from sensor package 62 and implements the governing equation to calculate a firing solution and control the pulse generator 52 to execute the firing solution to modulate repetition rate 56 (frequency) and amplitude 55 (peak pressure) to place a specified peak pressure on and coupled into a target 60 In this embodiment, the governing equation includes at least the range-to-target and Target Coupling Efficiency (f) components. The weapon may be man portable or mounted on a platform (truck, jeep, plane, ship, helicopter etc.) The weapon may be aimed by the operator or via an automated aiming system.

In this embodiment, sonic pulse generator 52 is configured to generate a burst of multiple discrete sonic pulses at a fixed repetition rate within the burst, to modulate the fixed repetition rate in response to a frequency command signal and to modulate the burst pressure in response to a peak pressure command signal. The fixed repetition rate may vary from approximately 20 Hz (0.05 second spacing) to approximately 10 kHz (0.0001 second spacing) depending on the target's resonance characteristics. A given pulse generator 52 may only span a specific portion of this range depending on the intended use of the weapon. For example, if the weapon is dedicated to one class of targets, say human the weapon may be configured to generate pulses at a repetition rate that produces a frequency content that is centered at the nominal resonance frequency of that class. Modulation of the repetition rate would tune the frequency content to more closely match the measured resonance frequency of a particular person (target). Alternately, the weapon may be designed to address multiple target classes and thus require the capability to be tuned over a broader frequency range. Generally speaking, it will be preferable to have a narrow band frequency content e.g. <10% of the center frequency and typically <5%. Narrowband energy is more efficient and more effective coupling to the target. Bandwidth results from mistiming on both the duration and repetition rate of the pulses. The pulse generator, which may be a single generator, phased array of generators or superposition of generators, must produce sufficient peak pressure to place peak pressures on targets at considerable distances to achieve the desired effect. Different technologies based on, for example, combustion engines, pulse detonation engines, thermobaric or hyperbaric chambers or electromagnetic pulse loudspeakers may be configured to provide these capabilities depending on the performance requirements of a weapon. The generator may be fitted with a shock tube at its acoustic aperture. The shock tube tends to focus the beam (waves bound around and interfere inside the shock tube). The length (fixed or tunable) of the shock tube may be set so that its harmonic frequency (given by the Helmholtz resonance equation) matches the center frequency of the burst. This tends to amplify the desired frequency content and attenuate out of band energy. The shock tube can be viewed as providing impedance matching to provide optimal gain. The generator is typically configured to generate the sonic pulses as a plane-wave or Mach disc. The pressure of a plane-wave falls off as approximately as 1/range whereas the pressure of an omni-directional wave falls off as 1/range². The plane wave may be generated directly if the acoustic aperture is sufficiently large (greater than or equal to the wavelength of the burst) or via a horn, parabolic reflector or phased array.

Sensor package 62 includes a range sensor 70 and a target absorption sensor 72. Range sensor 70 may comprise a laser rangefinder. The operator may use the range sensor to make discrete readings of the range-to-target that are fed to the controller. Alternately, the range sensor may be part of an automated laser aiming system (LAS). that tracks the target and provides updates of the range-to-target that are fed to the controller. The LAS generates beam steering commands to a gimbal mechanism to slew the pulse generator and place the burst of sonic pulses on a desired aim point at the target. The LAS enables precise beam placement through adaptive matching of the desired aim point and the current location of the transmitted pulse energy. Target absorption sensor 72 may comprise a laser Doppler vibrometer. Again the absorption sensor may be controlled by the operator or tied to the LAS. The sensor transmits a signal and detects the reflected signal to extract absorption characteristics. The absorption characteristics define the Target Coupling Efficiency (f) and more specifically resonance modes of a target at which pressure energy is efficiently coupled. For example, the center frequency of the burst may be tuned to the resonance mode of the target. A sonar reflectometer may be used to measure both the range-to-target and the absorption characteristics. Sensor package 62 may include other sensors such as a visual sensor to assess a target package (e.g. individual person or group of persons, threat level, etc) or assess the effect of one or more shots on a target. The visual data may be evaluated by the operator or by the controller and used to control subsequent firing of the weapon.

Operator interface 64 suitably includes a touch-screen to display menus to the operator and facilitate operator selection of menu items and data input. The definition of menus and menu items may vary with the configuration of the weapon based on the mission and level of automation. The interface may include a select target menu with menu items person and IED, select effect menu including warn/discomfort, stun/disorient and incapacitate menu items for a human target. The interface may include a fire shot menu with menu items fire single shot, fire X shots at Y interval where the operator may specify the number of shots and the interval or automated fire. Automated fire may, for example, allow the operator or weapon system itself to assess whether the first shot had the desired effect on the target and, if not, to alter the firing solution to, for example, increase or decrease the peak pressure and fire another shot. The interface may include a select ground conditions menu with menu items dirt, grass, sand, water and concrete. Ground diffusion parameters for use in the governing equation may be stored in memory for each menu item. Upon operator selection of a specific menu item, the controller retrieves the parameters and uses them to calculate the firing solution. The interface may include a select beam coverage menu including, for example, individual person, small group or crowd. Operator selection of a particular coverage selects a beam width stored in memory for use in the governing equation and to control the pulse generator. The interface may include a select perimeter menu with pre-set perimeters of say 50 m, 100 m, 150 m, 200 m etc. This is a different mode of operation in which the weapon establishes a certain peak pressure (selected effect) at a certain range typically over a relatively wide beam width to keep potential hostile targets outside the perimeter. The weapon may be configured to fire only upon initiation of the operator, if the operator spots a target, upon initiation from an automated sensor system that detects targets near the perimeter or periodically to maintain the perimeter. The operator interface may be configured with other menus and menu items to provide for greater control over the weapon and effectiveness against potential targets.

Controller 68 suitably includes one or more computer processors and computer program instructions implemented on the one or more computer processors. Controller 68 may receive inputs from operator interface 64, sensor package 62 and memory 66 and generate a firing solution including one or more commands to control pulse generator 52 in accordance with the governing equations. Controller 68 may first define a burst including the number of pulses, pulse duration and nominal repetition rate. Controller 68 may then calculate the coupling efficiency as a function of frequency (and possibly range-to-target) and adjust the repetition rate to shift the frequency content of the burst towards improving energy transfer to the target. For example, the controller may adjust the repetition rate to shift the center frequency of the burst towards the resonance condition in the Target Coupling Efficiency (f) for the particular target. This provides a specific value for α_{coupling efficiency}. Controller 68 may then calculate the peak pressure requires of the weapon (P_{weapon}) to place the specified peak pressure (P_{target}) at and coupled into the target. The firing solution may therefore include one or more commands to tune the sonic pulse generator to produce pulses at the specified repetition rate, one or more commands to tune the sonic pulse generator to produce a burst of pulses with the specified peak pressure and one or more commands to initiate firing of the burst of pulses. The firing solution may also control the duration the peak pressure is applied to a target. This may be done by controlling the duration of individual pulses, the number of pulses in a burst or the number of shots fired. The nature of these commands will depend on the technology and configuration of the sonic pulse generator. For example, certain generators may require physical modifications to produce pulses at the specified rate whereas other generators may only require changes to the timing of the ignition signals. For example, certain generators may require physical modifications to produce pulses at the specified peak pressure whereas others may only require modulation of an amount of fuel or charge provided to the generator.

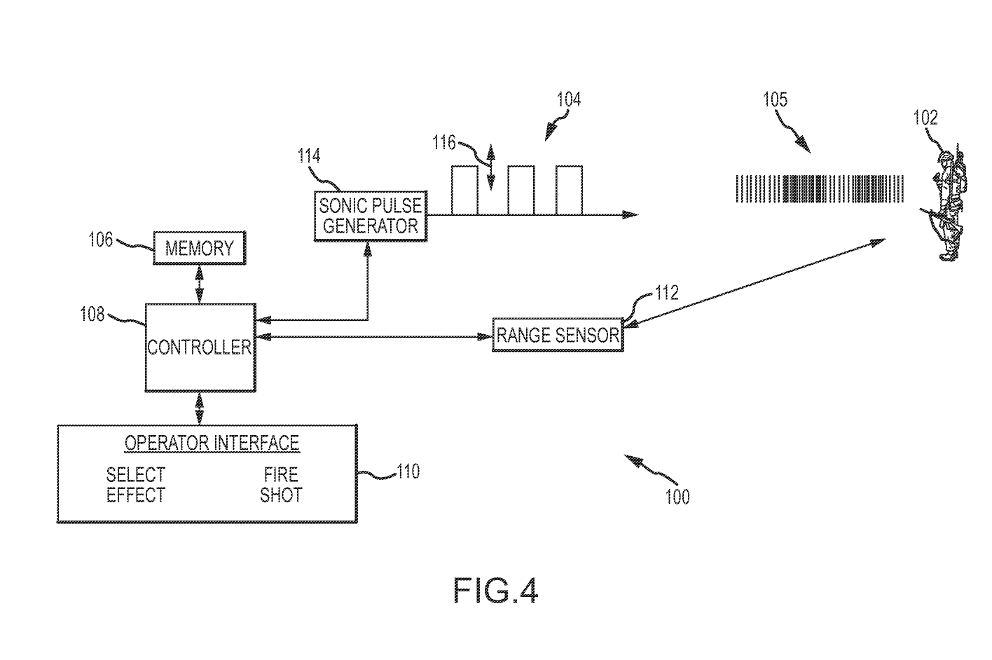

An embodiment of a controllable acoustic weapon 100 that incorporates modulation of the burst peak pressure based on range-to-target and possibly multiple-pulse bursts is depicted in FIG. 4. For single-pulse bursts, the frequency content is ill defined, defined only by the mechanical configuration of the generator as in existing acoustic weapons. This may be sufficient for certain weapon configurations. For multiple pulse bursts, the frequency content is well defined but fixed. If the weapon is configured for use against only a particular target class and the coupling efficiency and particularly the target coupling efficiency of that class of targets is well defined this approach may be sufficient. The burst may be generated to provide a somewhat broader frequency content to account for intra-class variations of specific targets. The elimination of the target absorption sensors and tunability of the pulse generator may simplify the weapon and reduce cost while still satisfying mission requirements.

In this embodiment, let us assume that weapon 100 is configured for use only with individual human targets 102 and that testing data indicates that resonance of the human target peaks at 200 Hz. The repetition rate of a three-pulse burst 104 is set at 5 ms to produce a center frequency of 200 Hz. The timing accuracy is such that the bandwidth is nominally 10% of the center frequency so that the frequency content spans approximately 190-210 Hz. This produces a longitudinal wave 105 on target.

Coupling efficiency parameters needed to determine the firing solution may be stored in memory 106 or hard coded into the controller 108. The Acoustic Coupling Efficiency for a 200 Hz burst is calculated and stored. Look up tables for Atmospheric Propagation Efficiency as a function of range-to-target are stored. A nominal value for

Ground Diffusion Efficiency may be stored. A value for Target Coupling Efficiency is stored. A nominal value for target apparent area may be stored. The weapon is configured to produce a certain beam width, which is stored.

The operator selects a desired effect e.g. warn/discomfort, stun/disorient and incapacitate for a human target using an operator interface 110. A range sensor 112 measures a range-to-target. Given the inputs of the selected effect and range-to-target, controller 108 computes a firing solution and generates one or more commands to a sonic pulse generator 114 to execute the firing solution. The only variable in this scenario being the peak pressure 116 generated by the weapon. Once the firing solution has been calculated and the pulse generator configured to execute the firing solution, the operator interface enables firing and the operator fires a shot. Configuring the pulse generator may, for example, involve changing the amount of fuel or charge and the amount of oxidizer to preferably, although not necessarily, maintain the stoichiometry of the mixture. Alternately, pressure may be modulated down from a maximum pressure using controllable baffles either inside the generator or at the exit aperture.

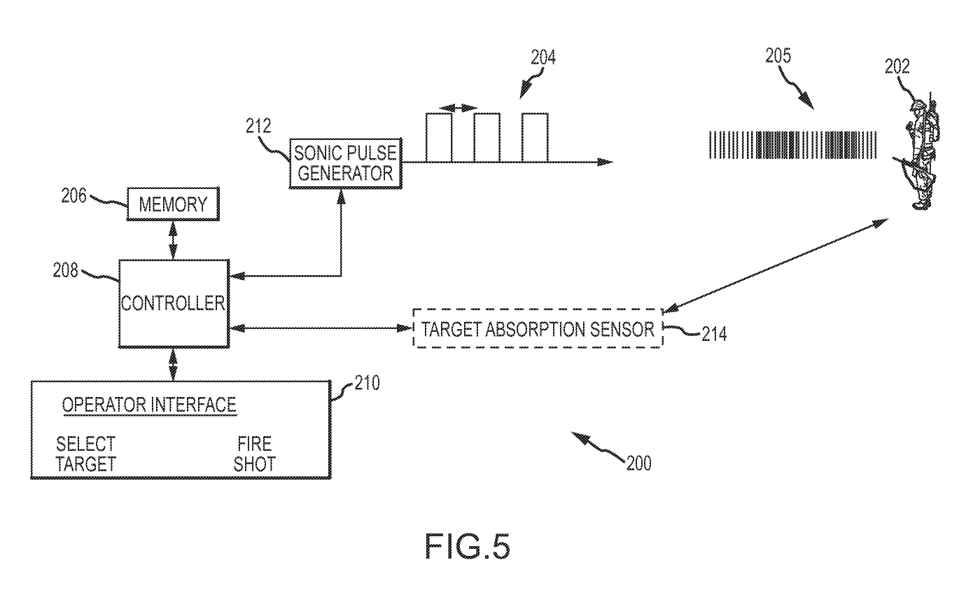

An embodiment of a controllable acoustic weapon 200 that incorporates multiple-pulse bursts and possibly modulation of the burst frequency is depicted in FIG. 5. The multiple-pulse burst provides a well-defined frequency content that couples more effectively to the target and greatly reduces the amount of wasted energy that is transmitted. A fixed-pressure, fixed-frequency weapon may, for example, be effective as a perimeter weapon against a specific class of targets to which the burst is tuned. A fixed-pressure, frequency modulated weapon may, for example, be effective as a perimeter weapon providing the capability to match resonance characteristics of a particular target or to prosecute different targets.

In this embodiment, let us assume that weapon 200 is configured for use only with individual human targets 202 and that testing data indicates that resonance of the human target peaks at 200 Hz. Let us initially assume that the repetition rate is not variable. The repetition rate of a three-pulse burst 204 is set at 5 ms to produce a center frequency of 200 Hz. The timing accuracy is such that the bandwidth is nominally 10% of the center frequency so that the frequency content spans approximately 190-210 Hz. This produces a longitudinal wave 205 on target.

Coupling efficiency parameters needed to determine the firing solution may be stored in memory 206 or hard coded into the controller 208. The Acoustic Coupling Efficiency for a 200 Hz burst is calculated and stored. Look up tables for Atmospheric Propagation Efficiency for a nominal range-to-target is stored. A nominal value for Ground Diffusion Efficiency may be stored. A value for Target Coupling Efficiency is stored. A nominal value for target apparent area may be stored. The weapon is configured to produce a certain beam width, which is stored.

In this configuration there are no variables, the firing solution is fixed. Controller 208 may be hard coded with the solution or may calculate it from the stored values. Sonic pulse generator is configured to execute the fixed firing solution e.g. a fixed repetition rate of the pulses and a fixed peak pressure produced by the burst. The operator uses an operator interface 210 to fire a shot. This weapon configuration has the benefits of not using any sensors or needing any reconfiguration or control of the sonic pulse generator 212 to fire a shot. This weapon configuration may be useful, for example, to establish a perimeter against human targets. The weapon is more effective because the frequency content of the burst is tuned to the target class and is more efficient because the frequency content is relatively narrowband. The narrowband frequency content also limits exposure of non-targets to pressure improving safety.

In another configuration weapon 202 includes a target absorption sensor 214 that measures the absorption characteristics of a target to provide the Target Coupling Efficiency (f). The controller 208 and pulse generator 212 are configured so that the repetition rate can be set for a given burst. The operator uses interface 210 to select the target. This may involve simply selecting a target to initiate measurement of the absorption characteristics and calculation of the firing solution if the weapon is only configured for a single target class. Alternately, the operator may have the option to select from different target classes e.g. human or IED. Controller 208 computes the firing solution including a repetition rate and configures the pulse generator to generate pulses at that repetition rate. The operator interface enables firing and the operator fires a shot. Configuring the pulse generator may, for example, involve simply changing the timing of the commands sent to the initiation system in the generator or may involve changing the input or output impedance of the generator itself.

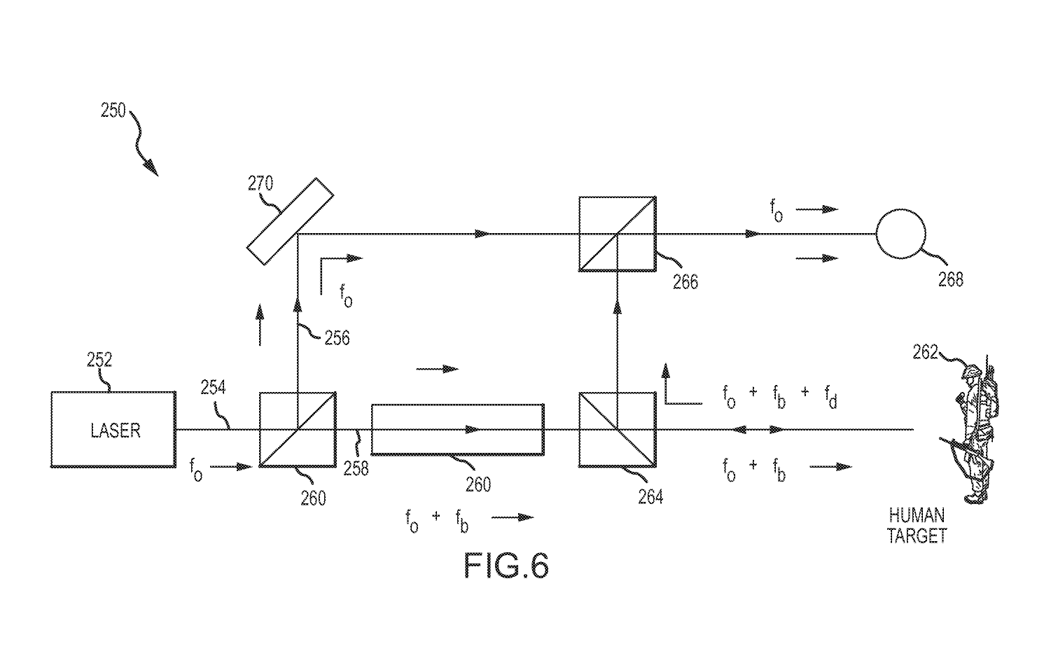

An embodiment of a target absorption sensor, namely a laser Doppler vibrometer (LDV) 250 is shown in FIG. 6. An LDV is an instrument that is used to make, non-contact vibration measurements of a surface. The laser beam from the LDV is directed at the surface of interest, and the vibration amplitude and frequency are extracted from the Doppler shift of the laser beam frequency due to the motion of the surface. The output of an LDV is generally a continuous analog voltage that is directly proportional to the target velocity component along the direction of the laser beam.

A vibrometer is generally a two-beam laser interferometer that measures the frequency (or phase) difference between an internal reference beam and a test beam. The most common type of laser in an LDV is the helium-neon laser, although laser diodes, fiber lasers, and Nd:YAG lasers are also used. The test beam is directed to the target, and scattered light from the target is collected and interfered with the reference beam on a photodetector, typically a photodiode. Most commercial vibrometers work in a heterodyne regime by adding a known frequency shift (typically 30-40 MHz) to one of the beams. This frequency shift is usually generated by a Bragg cell, or acousto-optic modulator.

A laser 252 emits a beam 254, which has a frequency fₒ. The beam is divided into a reference beam 256 and a test beam 258 with a beam splitter 260. The test beam then passes through the Bragg cell 260, which adds a frequency shift f_{b}. This frequency shifted beam then is directed to the target 262. The motion of the target adds a Doppler shift to the beam given by f_{d}=2*v(t)*cos(α)/λ, where v(t) is the velocity of the target as a function of time, α is the angle between the laser beam and the velocity vector, and λ is the wavelength of the light. Light scatters from the target in all directions, but some portion of the light is collected by the LDV and reflected by beam splitters 264 and 266 to the photodetector 268. This light has a frequency equal to fₒ+f_{b}+f_{d}. This scattered light is combined with the reference beam (reflected off mirror 270 and beam splitter 266) at the photo-detector 268. The initial frequency of the laser is very high (>10¹⁴ Hz), which is higher than the response of the detector. The detector does respond, however, to the beat frequency between the two beams, which is at f_{b}+f_{d} (typically in the tens of MHz range). The output of the photodetector is a standard frequency modulated (FM) signal, with the Bragg cell frequency as the carrier frequency, and the Doppler shift as the modulation frequency. This signal can be demodulated to derive the velocity vs. time of the vibrating target.

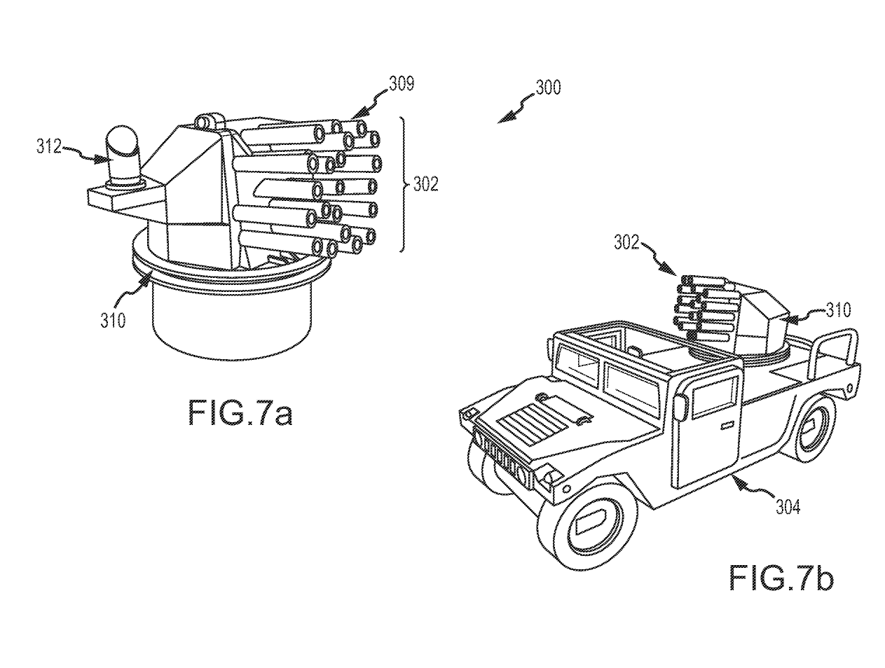

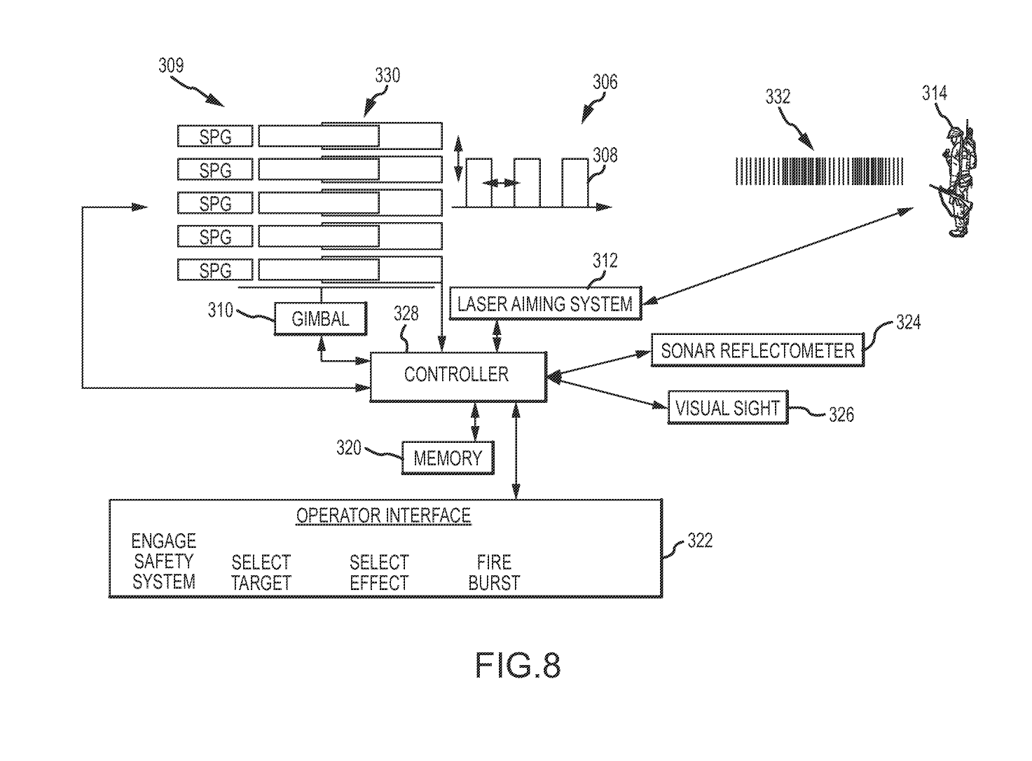

An embodiment of an acoustic weapon 300 configured as a phased array 302 mounted on a Humvee 304 is illustrated in FIGS. 7a-7b and 8. The phased-array configuration produces the burst 306 of multiple pulses 308 a plane wave or Mach disk from individual sonic pulse generators 309 whose acoustic apertures are too small to produce the desired wave directly. The phased array may also be used to steer the integrated beam and to control the frequency content of the integrated beam. The weapon may be mounted in general on any fixed or moving platform such as a jeep, truck, tank, boat, plane or helicopter. The weapon is mounted on a multi-axis gimbal 310 and provided with a laser aiming system 312 that tracks a target and slews the weapon on the gimbal to place a desired aim point on the target. This weapon is configured to modulate both the frequency and peak pressure of a given burst based on measured characteristics (e.g. absorption and range) of a selected target 314. Weapon 300 includes a memory 320 that stores the one or more parameters of the governing equation, an operator interface 322, a sonar reflectometer 324 that provides both the absorption characteristics of and range to target 314, a visual sight 326 to assess target 314 and to assess the effect on target 314 of one or more shots and a controller 328 that calculates the firing solution and issues one or more commands to the phased array to implement the firing solution. Instead of a sonar reflectometer the weapon may be fitted with separate range and absorption sensors. The operator interface may provide additional menu options such as those shown in FIG. 3.

Phased array 302 includes a plurality of sonic pulse generators 309 symmetrically arranged in a planar array about a central point. Each generator 308 is fitted with a shock tube 330 with an adjustable length. The adjustable length and shock tube itself are optional. The shock tube helps to focus and amplify the beam. The shock tube may also be used to shape the frequency content of the burst. The shock tubes may have the same length or different lengths (pre-set or tuned). Resonant properties of the individual generators and shock tubes and of the phases-array may be measured and fed back to controller 328. Each generator generators a burst of multiple pulses at substantially the same time. Interaction of the bursts of sonic pulses generates a Mach disk, a non-linear shock wave that travels along an axis perpendicular to the planar array with limited radial diffusion (e.g. the longitudinal or plane wave depicted in FIG. 2b). The Mack disk retains the intensity of the sonic pulses for a time and a distance significantly longer than that achieve from a single sonic source that produces an omni-directional wave 332.

The ability to accurately and reliably place a specific peak pressure on a target provides the level of control desired for both effectiveness and safety. The risk of applying too large a peak pressure that may injure a person is greatly reduced. Additional safety measures may be incorporated with the weapon. The safety system operates whenever the weapon is “on.” The system actively manages several operational aspects to help keep people near the device safe including the operator, bystanders and the target. The system may be composed of physical baffles, contact sensors, range sensors, accelerometers, and a controller to manage these inputs. The controller builds a representation of situational awareness using inputs from the sensors to determine if pressing the “Fire” button will result in a firing event or a safety halt.

As regards the system operator, baffles reduce pressure amplitude arriving at operator, contact sensors prevent unauthorized users from operating the weapon and prevent inadvertent firing if holding the weapon incorrectly or pointed in the wrong direction and accelerometers prevent the weapon from being used if pointed down at the ground or at other unsafe angles (range sensors would also acknowledge too-close-to-fire). As regards bystanders, baffles reduce pressure amplitude behind and near the weapon, range sensors halt pressure modulation in case bystanders move too close (laterally) to the acoustic beam during an active firing and, by design, the high directivity of the beam limits exposure to bystanders not being specifically targeted. As regards the target, range sensors halt pressure modulation in case targets move closer than a minimum engagement distance, if applicable, and video processing determines post-firing effects on targets. These and other safety measures may be incorporated into the weapon.

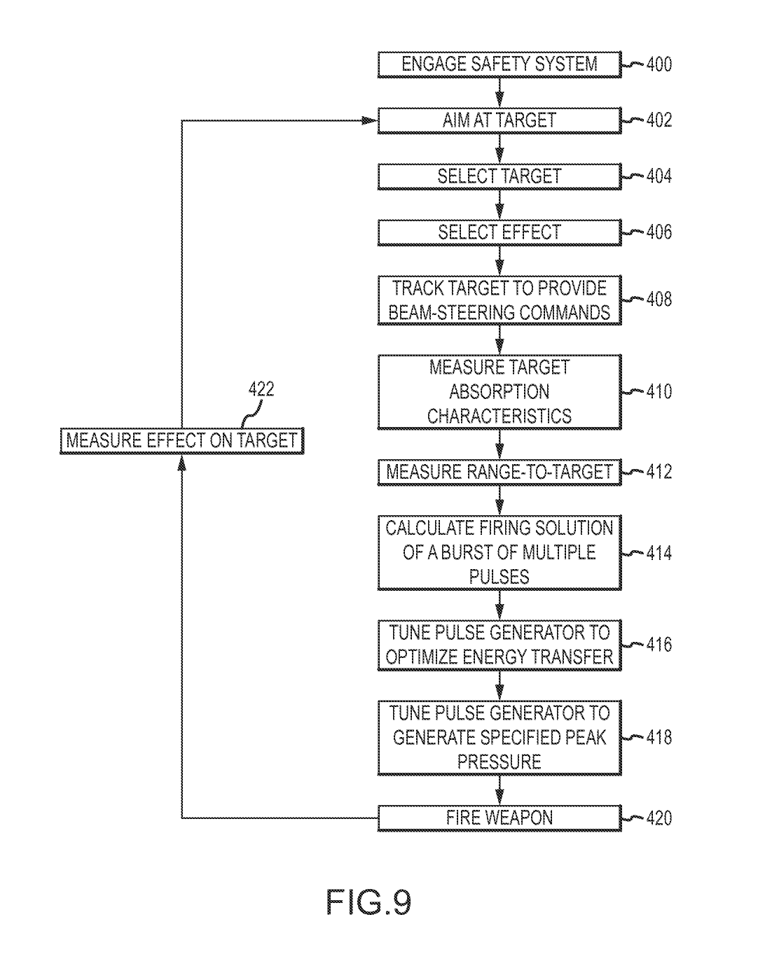

An exemplary sequence of steps for firing the weapon to place a specified peak pressure on target to achieve a selected effect is provided in FIG. 9. This sequence is merely exemplary, other combinations and ordering of steps are possible to similarly control the weapon. Turning on the weapon engages the safety system (400). The operator (or an automated control system), aims the weapon at the target (402), selects a target (404) and selects a desired effect (406). LAS 312 and controller 328 track the target to provide beam steering commands (408) to control the gimbal to slew the weapon to place the wave of pressure pulses on a desired aim point on the target. These or other beam steering commands from the LAS may be incorporated into the firing solution to modulate the pressure or control formation of the beam by the phased array. The weapon measures target absorption characteristics (410) and range-to-target (412). The controller processes the various inputs including the coupling efficiency parameters from memory, the absorption characteristics and range-to-target, the target selection and effect and possibly beam steering commands to calculate the firing solution (414) of a shot including a burst of multiple evenly spaced pulses. The firing solution may include a timing signal to initiate the burst including the number and spacing of the pulses. The firing solution may also include one or more commands to configure or tune the pulse generator to generate pulses at the repetition rate. The firing solution may also include one or more commands to configure or tune the pulse generator to generator a burst of pulses at the specified peak pressure. As needed, the pulse generator is tuned/configured in accordance with the one or more commands to optimize energy transfer from the weapon to the target (416). As needed, the pulse generator is tuned/configured in accordance with the one or more commands to generate the specified peak pressure (418). Provided the safety measures enable firing, the operator fires the weapon (420) and a single shot including a burst of multiple pulses is directed towards the target.

Measuring the effect on target (422) is optional but potentially useful. Depending on the range the operator may be able to assess the effect simply by watching the reaction of the target. Alternately, the operator may need a visual sight to accurately assess the reaction. Or the visual sight may be used to record a video signal that is processed by the controller to assess the effect. The operator or controller can use this information to determine whether another shot is warranted and, if so, whether the peak pressure associated with the previously selected effect should be adjusted or if a different effect should be selected. For example, a first shot may be set to warn/discomfort a person to encourage them to leave the area. If the person continues toward the operator or a protected location, the operator/controller may step the next shot up to the stun/disorient level. Conversely, if the first shot has incapacitated the target, the operator/controller may decide not to allow a second shot.

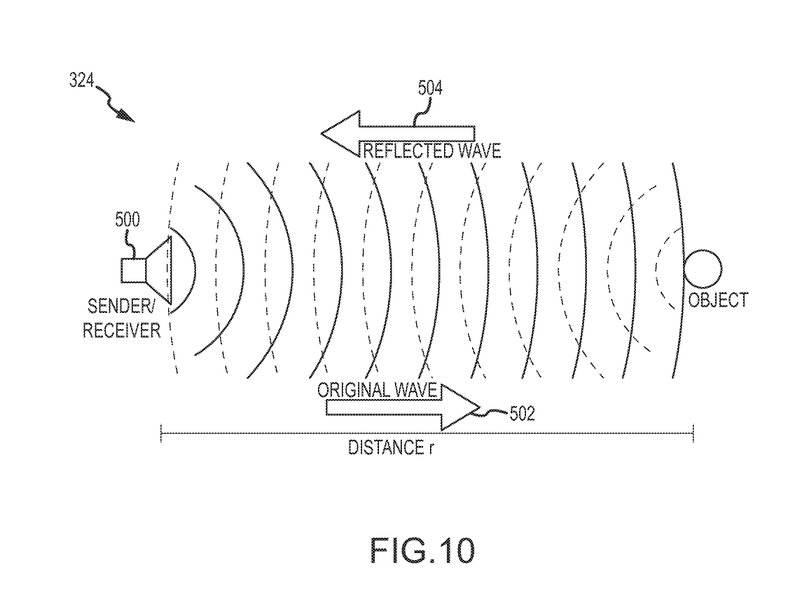

An illustration of the operation of sonar reflectometer 324 is depicted in FIG. 10. The reflectometer includes a transceiver 500 that transmits an original wave 502 ideally composed of equal amplitudes at all included frequencies. The reflected wave 504 returns with modified amplitudes representing the absorption characteristics of the target. The roundtrip travel time of the wave provides the range-to-target.

As described above the sonic pulse generator can be any technology that is capable of generating discrete sonic pulses at a repetition rate with sufficient accuracy to create a well defined frequency content (e.g. a bandwidth less than 10% of the center frequency) with sufficient amplitude to place substantial peak pressures on a target at distances of few to several hundred meters. One approach to achieve these peak pressures in short well-defined pulses is to deflagrate, combust or detonate fuel/oxidizer mixtures at periodic rates. A pulse manifold, pulse detonation engine (PDE) and a thermobaric explosive chamber are examples. In general, this type of generator includes a combustion chamber, a fuel intake for receiving fuel into the chamber, one or more oxidizer intake for receiving oxidizer (air or a specific oxidizer) into the chamber, an outlet acoustic aperture and one or more initiators for initiating combustion of the fuel-oxidizer mixture in the chamber to generate a discrete sonic pulse through the outlet acoustic aperture. A shock tube may be attached to the outlet to focus and amplify the beam and possibly shape the spectral content. The harmonic frequency of the shock tube may be pre-set or tuned to the repetition rate/center frequency of the burst.

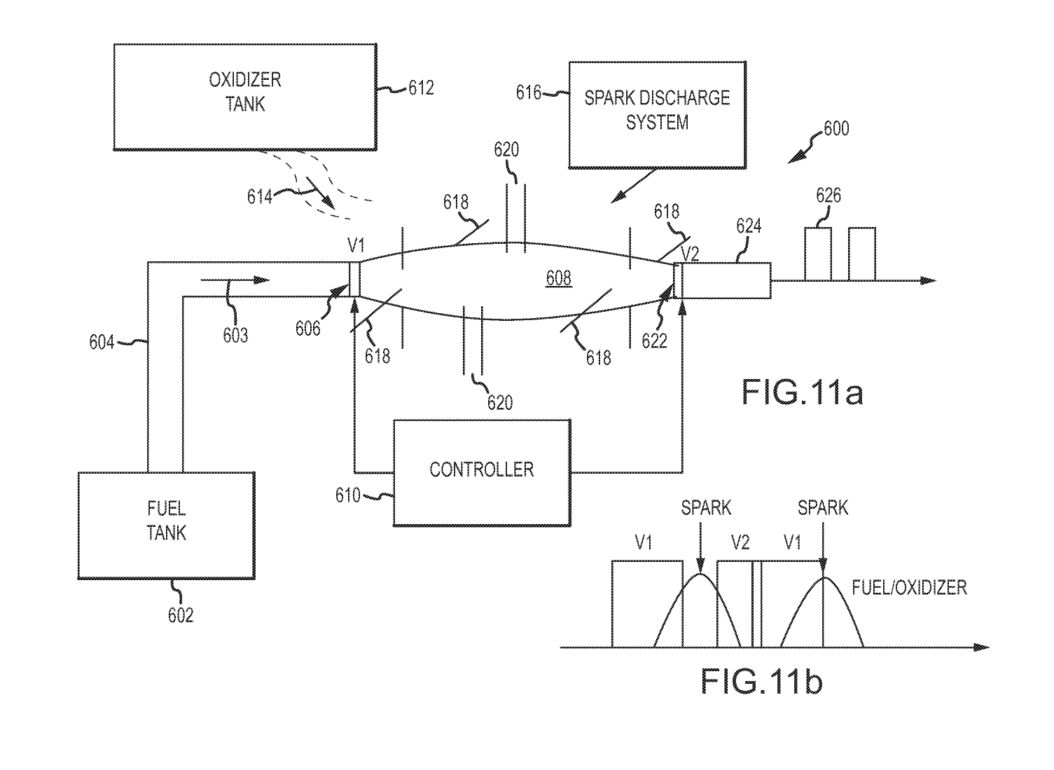

As shown in FIGS. 11a and 11b, a pulse manifold 600 provides a controlled environment to optimally deflagrate, combust, or detonate fuel/oxidizer mixtures at periodic repetition rates. The pulse manifold can account for multiple types of fuels and oxidizers and meters the real-time mixtures to improve system efficiency.

A fuel tank 602 holds pressurized fuel 603 and is connected via a high-pressure hose 604 to a fuel intake valve 606, electromechanical valve V1, coupled to one end of a chamber 608. V1 is managed by a controller 610. V1 may be a rotating valve or any number of fast open-close/close-open valve topologies. The chamber can be spherical, oblong, or shaped as necessary depending on packaging constraints of target applications.

An oxidizer tank 612 holds pressurized oxidizer 614. A spark discharge system 616 provides a spark to ignite the fuel/oxidizer mixture. Multiple ports 618 are used to evenly distribute oxidizers and spark during the various phases of device operation. The specific number and type of ports will vary depending on device size, fuel and oxidizer used, and target cost of the unit. It may be possible to co-locate spark and oxidizer functionality on a single port as shown here, thus reducing the overall number of ports on the pulse manifold. For clarity connection from the oxidizer tank and spark discharge system to each of the ports 618 is omitted. The chamber may be provided with one or more air intakes 620.

Fuel 603 moves into the chamber through the intake valve V1, is thoroughly mixed with oxidizer 614 (using strong jets of oxidizer into the chamber) and is deflagrated, combusted, or detonated through excitation by a spark-discharge system 616. The spark discharge system will vary depending on the specific fuel/oxidizer and target applications, but examples are automotive spark plugs and plasma-discharge electrodes. The resulting high-pressure explosion is sent out the exhaust valve of the pulse manifold. The exhaust valve 622, like the intake valve, is an electromechanical valve V2 actuated by the controller. A shock tube 624 may be coupled to the exhaust valve.

The controller 610 manages the timing of the overall system and makes it possible to fire a single shot including a single pulse 626, fire a single shot including a burst of multiple pulses or fire a plurality of shots (synchronously or asynchronously). The timing within a burst is fixed but may be changed between shots to change the burst frequency. A set of control algorithms describes the necessary timing interaction between V1 operation, oxidizer induction, spark discharge, and V2 operation as shown in FIG. 11b. The controller manages an appropriate stoichiometric mixture by balancing the operating dynamics of these criteria against inputs from various combustion by-product sensors such as an oxygen sensor (used in a way similar to automotive applications). This closed-loop control allows for diverse fuel/oxidizer combinations, improves efficiency, and reduces combustion by-products for a cleaner atmosphere.

The pulse manifold may used to implement a thermobaric or hyperbaric explosive approach. A thermobaric explosion is a “fuel-air” explosion and can produce a blast wave of significantly longer duration than those produced by condensed explosives. Thermobaric explosions rely on oxygen from the surrounding air. A hyperbaric explosion is a subclass of thermobaric explosions that employs enhanced or exotic oxidizers to increase the achievable impulse. Depending on the heat (and latent heat) required to initiate each specific thermobaric detonation, the pulse manifold may be modified to include multiple chambers. In other words, a single chamber may not be able to produce pulses at a sufficiently high repetition rate. By staggering the detonation of multiple chambers, the effective repetition rate can be multiplied. Alternately, this same effect may be achieved with multiple single-chamber manifolds whose detonations are appropriately staggered. The thermobaric explosion may produce higher peak pressures but achieve lower repetition rates without using multiple manifolds or chambers.

A pulse detonation engine (PDE) provides a controlled environment to optimally detonate fuel/oxidizer mixtures at periodic repetition rates. As compared to a pulsed manifold, the PDE produces faster moving (supersonic) waves capable of producing large peak pressures more efficiently than the pulse manifold. The peak pressure may be modulated by directly controlling the amount of fuel for each detonation while maintaining the stoichiometry or by variably attenuating the pressure using baffles within the chamber or downstream of the PDE. One limitation of some current PDE designs is that the engine is configured to detonate at only a fixed repetition rate. This repetition rate being dictated by resonant properties of the chamber However, modifications can be to control the input impedance at the intake to the chamber or to control the output impedance at the outlet. Controlling the input impedance via a butterfly valve or tunable length intake changes the harmonic properties of the chamber to modulate the repetition rate directly. Control the output impedance via a shock tube shapes the frequency content towards the harmonic frequency of the shock tube. If the PDE is designed to support a repetition rate at the nominal resonance frequency of a target class, modulation of the input or output impedance may be effective to tune the PDE to the resonance properties of a particular target in that class.

In a generalized PDE, fuel and oxidizer (e.g., oxygen-containing gas such as air) are admitted to an elongated combustion chamber at an upstream inlet end. An igniter is utilized to detonate this charge (either directly or through a deflagration-to-detonation transition (DDT)). A detonation wave propagates toward the outlet at supersonic speed causing substantial combustion of the fuel/air mixture before the mixture can be substantially driven from the outlet. The result of the combustion is to rapidly elevate pressure with the chamber fore substantial gas can escape inertially through the outlet.

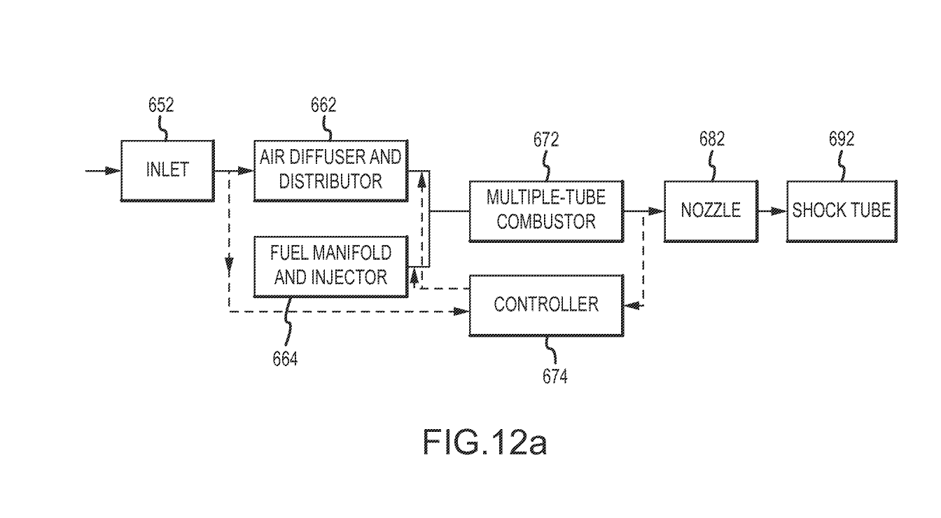

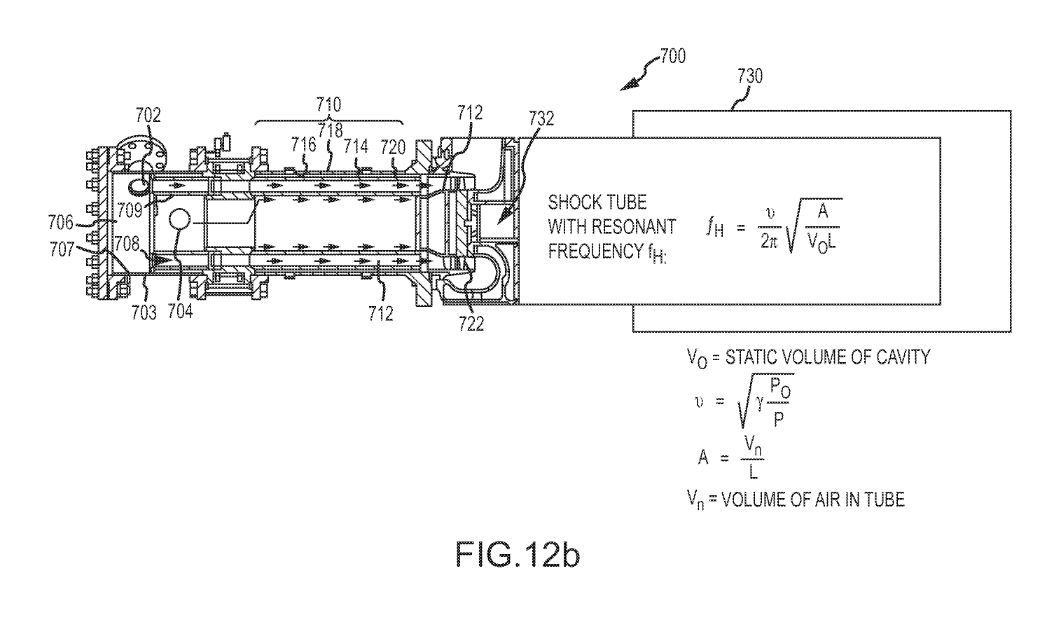

A block diagram of a generalized pulse detonation engine (PDE) 650 appears in FIG. 12a. Air is brought inside through an inlet 652 and is temperature modulated and prepared in an air diffuser and distributer 662. The air passes into the combustion chamber through the fuel manifold and injector 664. Fuel, metered by a valve controlled by controller 674, is allowed to enter for a specified amount of time to fill a pre-defined percentage of the combustion chamber volume based on the velocity of air through the system. The fuel valve is then closed and the mixture is initiated using a spark located downstream of the fuel manifold. The initial flame kernel expands as it propagates down the multiple-tube combustor 672. The flame speed increases as it propagates, eventually transitioning to a supersonic detonation wave. The gases are pushed through a nozzle 682 and flow into a shock tube 692, releasing into the atmosphere as an overpressure event. The multiple-tube combustor 672 is then purged of combustion products and refilled with fuel to repeat the cycle. Controller 674 coordinates timing of the system, including control of a fuel manifold and injector 664, and provides mixture control by comparing inlet 652 air with combustion by-products at the exit nozzle 682. Controller 674 provides direct controllability of pressure amplitude and operating frequency of the PDE.

In an embodiment shown in FIG. 12b, a PDE 700 comprises a primary air inlet 702 and a secondary air inlet 704. The primary inlet 702 is configured to allow primary air (e.g., oxygen-containing gas such as air) from a primary air source to be directed to a primary air plenum 706. Similarly, the secondary air inlet 704 is configured to allow secondary air from a secondary air source to be directed to a secondary air plenum 708. The primary air plenum 706 is substantially isolated from the secondary air plenum 708. Substantially isolated, as used in relation to the primary air plenum 706 and the secondary air plenum 708, refers to less than or equal to 5 volume percent of primary air flow into the secondary air plenum 708, and even more specifically less than or equal to 1 volume percent of primary air flow into the secondary air plenum 708. In one embodiment, the primary air plenum 706 is hermetically sealed from the secondary air plenum 708.

In one embodiment, the source of primary air and secondary air may be the same. In other embodiments, the source of primary air and secondary air may be different. Sources of primary and secondary air include any oxygen containing gas, such as gases from a compressor(s) (not shown), and the like. In one embodiment, the primary air is oxygen. In other embodiments, the primary air is air.

In one embodiment, the primary air plenum 706 is defined by an inner wall 707 of a housing 703 for the PDE 700 and an outer wall 709 of an inner housing that defines the secondary air plenum 708. While the primary air plenum 706 and the secondary plenum 708 are illustrated as having a substantially circular cross-section, the plenums 706 and 708 can comprise non-circular cross-sections as well.

The primary air plenum 706 is configured to allow the primary air to flow into a pulse detonation combustor 710 comprising a plurality of pulse detonation chambers 712. More particularly stated, the primary air is directed to each pulse detonation chamber 712. Arrows illustrate the general flow direction of primary air. Exemplary pulse detonation chambers include, but are not limited to detonation tubes, shock tubes, resonating detonation cavities and annular detonation chambers. The total number of pulse detonation chambers varies depending on the application.

In operation, the primary air and fuel are introduced into each pulse detonation chamber 712 and are detonated either by external ignition, such as spark discharge or laser pulse, or by gas dynamic processes, such as shock focusing, autoignition or by another detonation (cross-fire). In one embodiment, the charge(s) of primary air and fuel are detonated in parallel, i.e., each charge is detonated at substantially the same time. In various other embodiments, the charges are detonated at different times.

Meanwhile, secondary air from the secondary air plenum 708 is directed to a cooling plenum 714 defined by an inner wall 716 of a coaxial liner 718 and an outer wall 720 of the PDC 710. Arrows illustrate the general flow direction of primary air. Secondary air travels along cooling plenum 714 acting to cool the PDC 710 and to cool downstream components including, but not limited to, a single stage axial turbine 722. In other embodiments, a multiple stage axial turbine can be employed. The cooling plenum 714 and each pulse detonation chamber 712 are in fluid communication with the axial turbine 722 via transition piece 724. The transition piece 724 is configured to modify the velocity profile of the high-pressure gas exiting the pulse detonation chamber(s) 712 and is configured to allow mixing of the secondary air from the cooling plenum 714 with the high-pressure gas from the pulse detonation chamber 712. The exact shape of the transition piece will vary depending on the desired application. An exemplary transition piece 712 comprises a truncated funnel shape. The transition piece is configured to direct the secondary air from the cooling plenum and exhaust from each pulse detonation chamber 712 to the axial turbine 722. The axial turbine 722 can be used to provide thrust (high pressure pulses) via the expulsion of the exhaust gases. A more detailed description of a core PDE are provided in US Pat. Pub. No. 2008/0006019 entitled “Pulse Detonation Engines and Components thereof” published Jan. 10, 2008, which is hereby incorporated by reference. The described PDE is merely exemplary. One of ordinary skill in the art will appreciate that other configurations of the PDE may be used.

As shown in FIG. 12, the core PDE 700 may be modified in order to produce well defined pulses, to modulate the repetition rate of the pulses and to modulate the peak pressure of the pulses. As mentioned previously the nominal detonation rate of the PDE is determined by the resonance properties of the chamber. To generate a burst including multiple pulses, the controller generates a timing signal including the desired number of pulses at the nominal detonation rate. This in turn produces a burst of multiple pulses at a repetition rate approximately equal to the detonation rate.

A shock tube 730 is fitted to the outlet 32 of the PDE. The high-pressure waves bounce around and interfere inside shock tube 730 which is either preset or tuned to have a harmonic frequency f_{H} at the desired center frequency of the burst. The shock tube has the effect of focusing and amplifying the wave within the desired band and attenuating the out of band components.

The repetition rate of the pulses produces by the PDE may, for example, be modulated in one of two ways. First, means may be provided and controlled to modulate the input impedance to the PDE. This has effect of changing the resonance properties, hence detonation rate of the chamber. The control generates the timing signal at the shifted detonation rate. One way to control the input impedance is with a butterfly valve coupled to primary inlet 702. Another approach is to construct the inlet 702 with a variable length. Second, the shock tube 730 can be preset or tuned to the desired repetition rate, which is a little different than the nominal detonation rate. In this case, the PDE generates pulses whose frequency content is centered at the detonation rate. However, the shock tube tries to reshape the frequency content by amplifying components at the desired repetition rate and attenuating other components. For example, if the detonation rate is 190 Hz and the desired repetition rate is 200 Hz a shock tube will reshape the frequency content around 200 Hz.

The burst pressure may, for example, be modulated in one of two ways. First, the amount of fuel (and oxidizer to preferably maintain the stoichiometry of the mixture) may be varied to control the size of the detonation and the pressure wave. Second, the amount of fuel may be fixed to produce a maximum pressure and baffles either within the chamber or just downstream of the PDE controlled to attenuate the pressure.

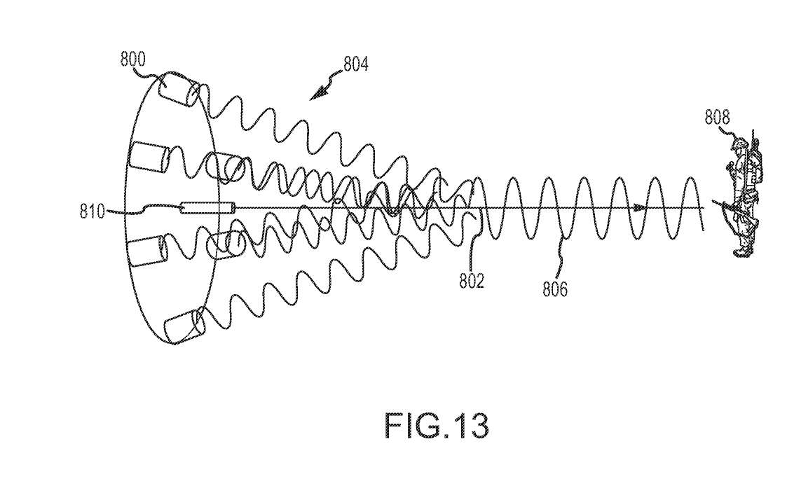

As shown in FIG. 13, multiple sonic pulse generators 800 are placed in a circumferential arrangement inwardly pointed toward a desired focal 802. The sonic pulses 804 from each generator are combined via constructive interference using the principle of superposition to form intensified sonic pulses 806 that are directed at a target 808. A laser rangefinder 810 may be placed at the center of the arrangement (or elsewhere) illuminate the target and measure range-to-target.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. An acoustic weapon, comprising:
a sonic pulse generator configured to generate discrete sonic pulses at a repetition rate;
a sensor configured to measure a range-to-target; and
a controller configured to control the sonic pulse generator to generate a single shot including a burst of multiple pulses at a fixed repetition rate, to adjust the fixed repetition rate to shift the frequency content of the burst in accordance with a target coupling efficiency towards improving energy transfer to the target and to adjust the peak pressure of the burst in accordance with the range-to-target towards applying a specified peak pressure to the target.

2. The acoustic weapon of claim 1, wherein the repetition rate is at least 20 Hz.

3. The acoustic weapon of claim 1, wherein the bandwidth of the frequency content is at most 10% of its center frequency.

4. The acoustic weapon of claim 1, wherein the controller varies the fixed repetition rate between multiple shots.

5. The acoustic weapon of claim 1, wherein the controller adjusts the fixed repetition rate to shift the frequency content of the burst towards a resonant mode of the target.

6. The acoustic weapon of claim 1, further comprising:
a sensor configured to measure the target coupling efficiency.

7. The acoustic weapon of claim 6, wherein the sensor comprises a laser Doppler vibrometer.

8. The acoustic weapon of claim 6, wherein the sensor includes a sonar device that provides both the target coupling efficiency and the range-to-target.

9. The acoustic weapon of claim 1, wherein the target coupling efficiency for a plurality of targets is stored in the controller, said controller selecting the appropriate target coupling efficiency based on a target selection.

10. The acoustic weapon of claim 1, wherein said controller adjusts the peak pressure of the burst in accordance with the target coupling efficiency.

11. The acoustic weapon of claim 1, wherein said controller adjusts the peak pressure of the burst in accordance with an apparent target area.

12. The acoustic weapon of claim 1, wherein said controller adjusts the peak pressure of the burst in accordance with a beam width of the burst of pulses.

13. The acoustic weapon of claim 1, wherein said controller controls a total duration the specified peak pressure is on target.

14. The acoustic weapon of claim 1, further comprising:
a sensor configured to measure a characteristic of the target indicative of an effect on the target of the exposure to the burst of pulses.

15. The acoustic weapon of claim 14, wherein the controller adjusts the peak pressure of a subsequent shot based on the measured characteristic.

16. The acoustic weapon of claim 1, further comprising:
a gimbal mechanism for slewing the acoustic weapon; and
a laser aiming system (LAS) that generates beam steering commands to the gimbal mechanism to place the burst of sonic pulses on a desired aim point at the target,.

17. The acoustic weapon of claim 1, further comprising:
an operator interface configured to facilitate operator selection of a type of target and a specified effect on target and to fire the weapon.

18. The acoustic weapon of claim 1, wherein the sonic pulse generator comprises:
a combustion chamber;
a fuel intake for receiving fuel into the chamber;
an oxidizer intake for receiving oxidizer into the chamber;
an outlet; and
an initiator for initiating combustion of the fuel-oxidizer mixture in the chamber to generate a discrete sonic pulse through the outlet.

19. The acoustic weapon of claim 18, wherein the sonic pulse generator is a pulse detonation engine (PDE), further comprising:
a shock tube coupled to the outlet,
wherein said initiator detonates the fuel-oxidizer at supersonic velocities;
wherein said controller adjusts the peak pressure by controlling the amount of fuel/oxidizer or by attenuating the discrete sonic pulses, and
wherein said controller adjusts the frequency by controlling the input impedance at the oxidizer intake or by adjusting the length of the shock tube.

20. The acoustic weapon of claim 18, wherein the sonic pulse generator is a pulse manifold, said fuel intake comprises an intake valve, said oxidizer intake comprises multiple ports distributed around the chamber, said outlet comprises an exhaust valve and said initiator comprises multiple spark discharge ports distributed around the chamber, said controller controlling the timing of the intake valve, oxidizer induction, spark discharge and the exhaust value to fire the single shot including a burst of multiple pulses at the fixed repetition rate.

21. The acoustic weapon of claim 18, further comprising:
a shock tube coupled to the outlet, said shock tube having a harmonic frequency approximately equal to the repetition rate of the pulses in the burst.

22. The acoustic weapon of claim 1, wherein a plurality of sonic pulse generators are arranged in a phased array, each said generator further comprising a variable-length shock tube, said controller adjusting the length of the shock tubes to form a beam of sonic pulses.

23. The acoustic weapon of claim 1, wherein a plurality of sonic pulse generators are placed in a circumferential arrangement inwardly pointed toward a desired focal, said sonic pulses combined via superposition to form intensified sonic pulses.

24. An acoustic weapon, comprising:
a sonic pulse generator configured to generate discrete sonic pulses;
a sensor configured to measure a range-to-target; and
a controller configured to control the pulse generator to adjust the peak pressure of a single shot including a burst of one or more sonic pulses in accordance with the range-to-target towards applying a specified peak pressure to the target.

25. The acoustic weapon of claim 24, wherein the burst comprises a plurality of sonic pulses at a fixed repetition rate.

26. The acoustic weapon of claim 25, wherein the repetition rate is at least 20 Hz.

27. The acoustic weapon of claim 25, wherein the bandwidth of the frequency content is at most 10% of its center frequency.

28. The acoustic weapon of claim 24, wherein the weapon is configured to engage a target class having a nominal resonance frequency, said fixed repetition rate set at approximately said nominal resonance frequency.

29. The acoustic weapon of claim 28, wherein said target class is characterized by a target coupling efficiency, said controlled configured to adjust the peak pressure in accordance with the range-to-target and the target coupling efficiency.

30. An acoustic weapon, comprising:
a sonic pulse generator configured to generate discrete sonic pulses at a repetition rate; and
a controller configured to control the sonic pulse generator to fire a single shot including a burst of multiple discrete sonic pulses at a repetition rate, the frequency content of the burst of sonic pulses being controlled by the repetition rate.

31. The acoustic weapon of claim 30, wherein the repetition rate is at least 20 Hz.

32. The acoustic weapon of claim 30, wherein the bandwidth of the frequency content is at most 10% of its center frequency.

33. The acoustic weapon of claim 30, wherein the weapon is configured to engage a target class having a nominal resonance frequency, said fixed repetition rate set at approximately said nominal resonance frequency.

34. The acoustic weapon of claim 30, wherein the controller is configured to adjust the fixed repetition rate to shift the frequency content of the burst in accordance with a target coupling efficiency towards improving energy transfer to the target.

35. The acoustic weapon of claim 30, further comprising:
a sensor configured to measure the target coupling efficiency.
